(19) United States
(12) Patent Application Publication
(10) Pub. No.: US 2010/0058888 A1
(43) Pub. Date: Mar. 11, 2010

(54) Drive shaft

(76) Inventors: Oskar Mueller, Thueringerberg (AT); Peter Meusburger, Mauren (LI)

Correspondence Address: WENDEROTH, LIND & PONACK, L.L.P., 1030 15th Street, N.W.,, Suite 400 East, Washington, DC, 20005-1503, US

(21) Appl. No.: 12/588,488

(22) Filed: Oct. 16, 2009

Related U.S. Application Data
(63) Continuation of application No. PCT/AT08/00113, filed on Mar. 28, 2008.

(30) Foreign Application Priority Data
Apr. 19, 2007 (DE) 10 2007 018 920.8

(51) Int. Cl. F16H 53/00; B21D 53/84

(52) U.S. Cl. 74/567; 74/570.1; 29/888.1

(57) ABSTRACT

A drive shaft includes at least two coaxial hollow shafts spaced apart in the direction of the rotational axis of the drive shaft, and each of the hollow shafts has an inner opening. At least one function unit, which includes at least one function part disposed, with reference to the direction of the rotational axis of the drive shaft, between a first and a second of the hollow shafts and first and second engagement sections extending in the direction of the rotational axis of the drive shaft, of which the first engagement section is disposed in the inner opening of the first hollow shaft and of which the second engagement section is disposed in the inner opening of the second hollow shaft. The engagement sections of the function unit are pressed into the inner openings of the hollow shafts with the formation of a particular press fit and the first and second hollow shafts are rigidly connected with one another via the function unit. The outer surfaces of the engagement sections include material elevations and/or the wall, delimiting the inner opening of the hollow shaft, of the particular hollow shaft in the end section, in which the press fit is formed with the particular engagement section of the function unit, includes material elevations.

This is a continuation application of international application PCT/AT2008/000113, filed Mar. 28, 2008, the entire disclosure of which is incorporated herein by reference.

### BACKGROUND OF THE INVENTION

a) Field of the Invention

The invention relates to a drive shaft comprising at least two coaxial hollow shafts spaced apart in the direction of the rotational axis of the drive shaft, each of the hollow shafts having an inner opening, and which comprises at least one function unit which comprises at least one function part disposed, with reference to the direction of the rotational axis of the drive shaft, between a first and a second of the hollow shafts. First and second engagement sections extend in the direction of the rotational axis of the drive shaft, and the first engagement section is located in the inner opening of the first hollow shaft and the second engagement section is located in the inner opening of the second hollow shaft. The engagement sections of the function unit are pressed into the inner openings of the hollow shafts each forming a particular press fit, and the first and the second hollow shafts are rigidly connected with one another via the function unit. The invention furthermore relates to a method for the production of such a drive shaft.

b) Description of Related Prior Art

The invention addresses in particular assembled cam shafts. By cam shaft is to be understood in general a shaft with at least one cam, wherein in the operational state the cam is in contact with a cam follower. Through a turning of the shaft, the cam follower is actuated according to the sequence or “program” anchored in the cam contour. Thus under the term cam shaft are to be subsumed also adjustment shafts for mechanically variable valve drives. In this case, the cams are realized as cam disks (for example as eccentric disks) and correspondingly disposed as adjustment disks on the shaft. Such shafts are also referred to as eccentric shafts.

For the production of assembled cam shafts, function elements, such as in particular cam drive wheels, bearings, axial bearing disks, sensor rings, cam shaft adjusters and the bearing shaft are produced individually. The function elements are subsequently positioned on the bearing shaft, which serves as a bearer and for the transmission of the rotation, and secured on the shaft by means of a suitable jointing method. A number of methods for the production of assembled cam shafts are known in prior art.

DE 4121951 C1 introduces a method for the production of assembled cam shafts in which on the bearing shaft regions are widened beyond the original shaft diameter by means of threading-like roller-burnishing and, subsequent to the widening of a region, a cam, whose inner cutout has a diameter less than the outer diameter of the widened shaft regions, is axially slid on and pressed onto the widened shaft region. The cam has a base circle region and a valve elevation region. The diameter of the cam in the base circle region is correspondingly greater than the diameter of the inner cutout of the cam. The difference between these two diameters is referred to as flange width or as band thickness of the cam in the base circle region. The band thickness must be of appropriate thickness in order for it to absorb the stresses of the jointing process. In this manner, through the diameter of the bearing shaft a minimally possible diameter of the cam in the base circle region is predetermined. Conventional standard values for minimal band thicknesses are approximately 4 mm.

In many application cases of motor engineering, however, it is desirable to have a relatively large diameter of the bearing shaft since the bearing shaft frequently is utilized as bearing diameter for the bearing of the drive shaft or the cam shaft. Large diameters of the bearing shaft, moreover, offer advantages with respect to the rigidity of the entire drive shaft. On the other hand, for example in the case of cam shafts, it is frequently desired for reasons of the motor that the diameters of the cams are as small as possible in the base circle region. As explained, these diameters, at a given diameter of the bearing shaft, are however limited through the required band thicknesses of the cams.

JP 2004 011 699 A discloses an assembled came shaft, in which the completely finished cam can be seated tightly on the bearing shaft. To secure the cams in position, bilaterally axially projecting hollow-cylindrical extensions are provided on them. These extensions are pressed onto widened shaft regions provided with encircling elevations. For this purpose these hollow-cylindrical extensions must have sufficient band thicknesses. The cams must also have minimum band thicknesses of a few mm.

DE 198 37 385 A1 discloses a drive shaft implemented as an assembled cam shaft of the type described in the introduction. The cam shaft comprises cams, a chain or toothed belt wheel, hollow shafts forming intermediate pieces, and a cap-shaped end piece. These separate parts are assembled and, by means of a centrally acting tension element, tightened axially force-fittingly and/or force fittingly with positive locking. A principal disadvantage of this cam shaft is the low rigidity of a shaft tightened in this manner or the very high requirements made of the tension element; conventionally an extension bolt. Furthermore, through the employment of a tension element, the weight and the material requirement is increased since the inner hollow volume of the tube is at least partially filled with the tension element. In one embodiment, tubular centering pieces serve for centering the cams. A particular centering piece is seated with a suitable fit in the cam and includes on both sides engagement sections projecting above the cam, with which it is received in the end sections of the adjacent hollow shafts such that via this centering piece the cam is centered with respect to the hollow shafts and the hollow shafts are centered with respect to one another. The cam, together with the centering piece, can be viewed as a function unit.

EP 0 969 216 A2 discloses a cam shaft in which cams are strung onto a shaft with spacer sleeves disposed between them. The strung-together cams and spacer sleeves are axially clamped between terminating sleeves.

A drive shaft of the type described in the introduction is disclosed in U.S. Pat. No. 4,638,683. The drive shaft represents a cam shaft formed of several subshafts, wherein ceramic cam shaft sections representing function units are connected with one another via hollow shafts. Engagement sections of the function units are here pressed into the inner openings of the hollow shafts with the formation of a particular press fit. For additional securements against a turning out of place serve balls or the engagement sections are implemented polygonally.

### SUMMARY OF THE INVENTION

The invention addresses the problem of providing a drive shaft in which, in the proximity of at least one function part, disposed between two hollow shafts, the outer diameter of the function part, at least over a circumferential section of the function part can be kept slender, whereby the drive shaft can be implemented simple, robust and with relative low weight.

According to the invention this is achieved through a drive shaft comprising at least two coaxial hollow shafts spaced apart in the direction of the rotational axis of the drive shaft, each of the hollow shafts having an inner opening, and at least one function unit which includes at least one function part disposed, referring to the direction of the rotational axis of the drive shaft, between a first and a second of the of the hollow shafts and first and second engagement sections extending in the direction of the rotational axis of the drive shaft. The first engagement section is disposed in the inner opening of the first hollow shaft, and the second engagement section is disposed in the inner opening of the second hollow shaft. The engagement sections of the function unit are pressed into the inner openings of the hollow shafts forming a particular press fit and the first and the second hollow shafts are rigidly connected with one another via the function unit. The outer surfaces of the engagement sections and/or the wall delimiting the inner opening of the hollow shaft of the particular hollow shaft includes material elevations in the end section, in which the press fit with the particular engagement section of the function unit is implemented.

In a drive shaft according to the invention, the engagement sections of the function unit are pressed into the inner openings of the hollow shafts. The engagement sections are consequently held in the inner openings of the hollow shafts through a press fit or with the formation of an interference fit. Since the pressing-in takes place in the direction of the rotational axis of the drive shaft, this connection can also be referred to as a longitudinal press connection. The hollow shafts are thereby rigidly connected with one another via the function unit.

The at least one function part can, in particular, be such a part which, upon the rotation of the drive shaft, forms a gearing member to drive a gearing member cooperating with the drive shaft, preferably a cam or a gear-wheel. The at least one function part can, further, also be, for example, a bearing part bearing the drive shaft, a sensor ring or a drive gear driving the drive shaft.

In a preferred embodiment of the invention the drive shaft is a cam shaft, wherein the at least one function unit includes as a function part at least one cam or one cam disk.

In other embodiments of the invention, the drive shaft can be, for example, a gear-wheel shaft, in which the at least one function unit has at least one gear-wheel as the function part or it can be a differential gear shaft.

The longitudinal axes of the first and second hollow shafts coincide with the rotational axis of the drive shaft. The first and second hollow shafts have preferably the same outer and inner diameters. The longitudinal axes of the engagement sections of the function unit advantageously also coincide with the rotational axis of the drive shaft.

A particular engagement section, held in an inner opening of a hollow shaft through a press fit, is advantageously provided on its outer surface with material elevations, in particular beads, webs, teeth or the like. The heights of these material elevations are herein with advantage in the range from 0.03 mm to 0.4 mm. Additionally, or instead, the wall of the particular hollow volume receiving a connection pin could also be provided with material elevations, in particular beads, webs, teeth or the like. The heights of these material elevations are herein also with advantage in the range from 0.03 mm to 0.4 mm.

These material elevations are with advantage introduced using a forming process, such as roller-burnishing or knurling, into the surface of the connection pin and, if feasible, also into the inner surface of the hollow volume. The advantage consists in the material reinforcement entailed therein, which leads to a reduction of chips and the improvement of the connection.

In an advantageous embodiment of the invention the outer contour of the engagement section has substantially the form of a cylinder shell, i.e. apart from the preferably provided outer material elevations, end-side inlet chamfers, side form elements or the like. The inner openings of the hollow shafts, at least in their axial regions receiving the engagement sections, are preferably implemented substantially cylindrical over their entire axial extents, i.e. apart from optionally provided material elevations, an end-side inlet chamfer, side form elements or the like.

The outer shell surfaces of the hollow shafts are preferably substantially implemented in the form of a cylinder shell, i.e. apart from side form elements, chamfers, material elevations or the like.

Before the forming production of the material elevations, the inner diameter of the cylindrically implemented hollow volume is advantageously minimally greater than the outer diameter of the cylinder shell-shaped connection pin, such that both parts can be slid one into the other with minimal play, wherein only through the diameter enlargement or diameter reduction, respectively, connected with the generation of the material elevations, in at least one of the two parts, the partial overlap necessary for the interference fit is obtained. It becomes thereby possible to compensate form, dimension and position discrepancies of the cylindrical inner form of the hollow volume and of the cylindrical shell surface of the connection pin. Further, the orientation of the parts to be jointed with respect to each other is simplified. The connection is additionally with advantage so laid out that a widening of the outer diameter of the region of the jointing partner into which the connection pin penetrates, is nearly prevented. The values of the widening of the outer diameter should herein be below 0.2 mm, especially preferred below 0.05 mm. This reduces the material volume which must be removed if in the region of the jointing site a constant outer diameter is demanded. This further lowers the cracking risk in the wall of the hollow volume, such that the strength of the connection is ensured. In the case of a noncylindrical formation of the connection pin and of the hollow volume, this applies analogously. In this case the only minimal widening is even more important since nonround circumferential contours tend more readily to a notch effect and cracks can more easily form.

In an advantageous embodiment of the invention inlet chamfers are implemented at the ends of the hollow shafts and/or at the ends of the engagement sections directed toward one another.

The press fit formed between the particular engagement section and the particular hollow shaft is at least force-fit in the axial direction (=in the direction of the rotational axis of the drive shaft). The springback effects, in addition, a component of the connection acting form-fittingly in the axial direction, acting, for example through stress relief of a section of a material elevation disposed on the wall delimiting the inner opening of the hollow shaft and extending in the longitudinal direction, which section, referred to the slide-in direction of the engagement section into the inner hollow volume, is located behind a material elevation disposed on the outer surface of the engagement section and extending in the circumferential direction.

In the circumferential direction (thus with respect to a torque transmission) a particular engagement section is at least held under force fit through the press fit in the particular hollow shaft. The connection is preferably additionally implemented such that it is form-fit. For example, this can be attained through material elevations extending in the axial direction on the outer surface of the engagement section and/or on the wall encompassing the inner opening of the hollow shaft in its region of the press fit, which elevations during the formation of the press fit form into or carve into the material of the other parts connected via the press connection. The herein formed indentations are preferably not at all or only to a minimal degree metal-removing but rather are entirely, or at least largely, formed through material displacement.

In an advantageous embodiment of the invention the function unit comprises a shaft part coaxial with the rotational axis of the drive shaft, which part includes the first and second engagement sections. The function part and the shaft part are parts produced in separate fabrication processes and the function part is connected at least torsion-tight, preferably rigidly, with the shaft part. The shaft part preferably penetrates an inner cutout of the function part. The rigid seating tightly of the function part on the shaft part can take place in various manner under force and/or form and/or material fit, for example such as is known from the connection of cams with a bearing shaft in the case of assembled cam shafts. The connection can in particular be realized through a press fit. For such a press fit are under consideration again the implementation feasibilities described above in connection with the press fit between the particular engagement section and the particular hollow shaft. The press fit can, for example, be implemented such as is known of cam shafts with cams pressed onto a bearing shaft, for example in the manner described in the prior art cited in the introduction to the specification

An advantageous embodiment of the invention provides that the shaft part overall is substantially cylindrical, i.e. apart from material elevations, inlet chambers, side form elements or the like, wherein a substantially hollow-cylindrical implementation is preferred.

### BRIEF DESCRIPTION OF THE DRAWINGS

Further advantages and details of the invention will be described in the following with reference to the enclosed drawings, in which:

FIG. 1 shows an embodiment of a function unit implemented in the form of a cam, in oblique view,

FIG. 2 shows an embodiment of a function part implemented in the form of a cam disk or an eccentric disk, in side view,

FIG. 3 shows a schematic longitudinal center section through a cam shaft according to prior art,

FIG. 4 shows a longitudinal center section through a section of a cam shaft including a cam, according to a first embodiment of the invention (section line A-A of FIG. 5),

FIG. 5 shows a cross section through the cam shaft (section line B-B in FIG. 4),

FIG. 6a is an oblique view of the shaft part and of the cam of the function unit, before the cam is pressed on,

FIG. 6b a is n oblique view of the function unit and of the end sections of the first and of the second hollow shafts before they are pressed together,

FIG. 6c is an oblique view after the pressing-together,

FIGS. 7 to 9 are depictions analogous to FIGS. 4, 5 and 6c of a modified embodiment,

FIG. 10 shows a longitudinal center section of a section of a cam shaft according to a third embodiment of the invention,

FIG. 11 shows a longitudinal center section through a section of a cam shaft according to a fourth embodiment of the invention,

FIG. 12 shows a longitudinal center section through a section of a cam shaft corresponding to a fifth embodiment of the invention,

FIG. 13 shows a longitudinal center section through a section of a cam shaft according to a sixth embodiment of the invention,

FIG. 14 shows a longitudinal center section through a section of a drive shaft according to a seventh embodiment of the invention,

FIG. 15 shows a longitudinal center section through a section of a drive shaft according to an eighth embodiment of the invention,

FIG. 16 shows a section along line C-C of FIG. 8.

### DETAILED DESCRIPTION OF THE PREFERRED EMBODIMENTS

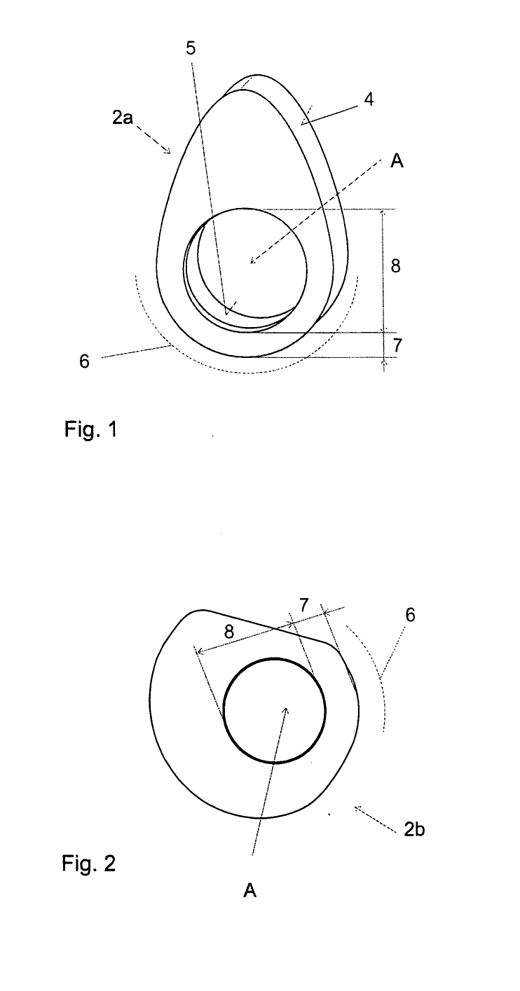

FIG. 1 shows by example as a function part of a cam shaft a cam 2a with a cam elevation of a cam peak. Its function face 4, with which, in the operating state of the cam shaft, a cam follower is in contact, is divided in its circumference into a base circle region 6 and a cam elevation region. The cam 2a includes a cutout A with an inner diameter 8. The difference between the outer diameter of the cam 2a and the inner diameter 8 in the base circle region 6 is referred to as flange width 7 or collar width or minimal band thickness. A wall 5 delimiting the inner cutout A can, as shown, be smooth or can have elevations, for example teeth extending in the axial direction of the inner cutout A.

The inner cutout A can include an inlet chamfer 9 in order to improve or facilitate the fixing of the cam 2a taking place preferably through axial pressing-in, as explained below. At its mouth the inlet chamfer 9 has an opening diameter minimally larger than the inner diameter 8 which is otherwise constant over the axial extent of the cutout A.

The inner cutout A is substantially cylindrical, i.e. apart from optionally provided elevations on wall 5, the preferably provided inlet chamfer 9 and potentially further side form elements (not shown in FIG. 1).

FIG. 2 shows as a further feasible embodiment of a function part of a cam shaft, a cam implemented in the form of a cam disk or eccentric disk 2b. The base circle region 6 extends here over a comparatively smaller section of the circumference. Again, an inner cutout A is provided, whose wall can be implemented in the manner described in connection with cam 2a. The inner diameter 8 of the inner cutout and the flange width 7 of the cam disk or eccentric disk 2b are drawn in. Such a cam shaft including cam disk or eccentric disks is also referred to as eccentric shaft.

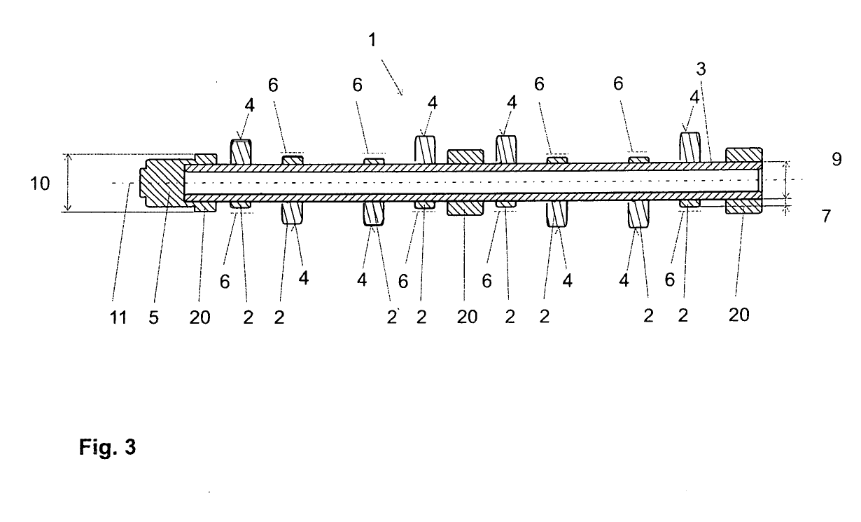

For clarification, in FIG. 3 is shown schematically a cam shaft according to the prior art, such as is substantially disclosed, for example, in DE 4121951 C1 and DE 19925028 A1. The cam shaft comprises a bearing shaft 3, implemented as a hollow shaft, and has a rotational axis 11, and function parts 2 fixed thereon, such as for example cams 2a with cam peaks according to FIG. 1 or in the form of cam or cams implemented as eccentric disks according to FIG. 2. The function parts 2 are axially pressed onto sections of bearing shaft 3, in which the bearing shaft 3 is widened in its circumference by means of a threading-like roller-burnishing. In the base circle region 6 of the function parts 2 the outer diameter results from the outer diameter 19 of bearing shaft 3 plus the flange width 7 of the particular function part 2. From the height of the cam elevation opposite the base circle region 6 or the height of the eccentric elevation opposite the base circle region 6 results the maximum outer diameter.

TAS a further function part, the cam shaft depicted in FIG. 3 includes bearings 20 with a bearing diameter 10 and a drive piece 21. Further function parts, as not conclusive, axial bearing disks, sensor rings and cam shaft adjusters can be provided. The further function parts can also be pressed axially onto the bearing shaft 3.

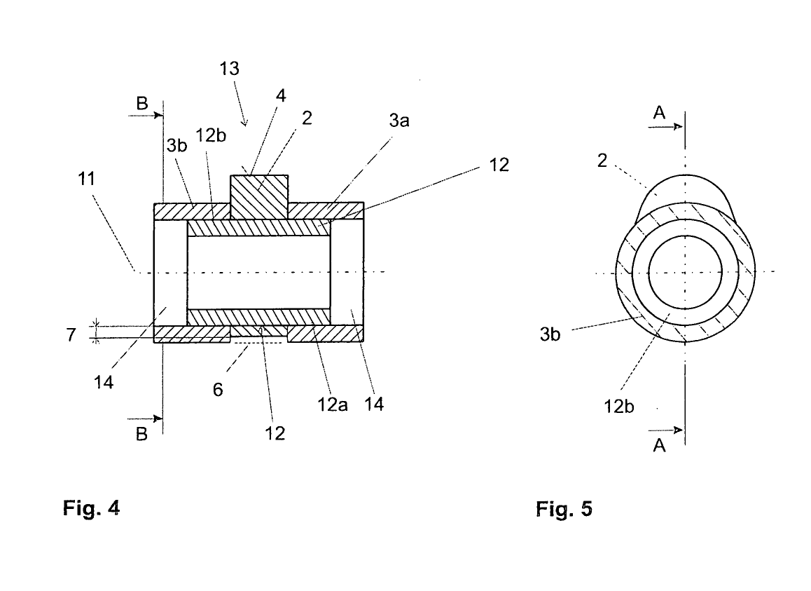

A first embodiment example of the invention will be explained in the following with reference to FIGS. 4 to 6, wherein for analogous parts identical reference symbols are used. Depicted is an axial section of a drive shaft implemented in the form of a cam shaft, wherein, in the depicted axial section, a function part 2 is implemented as a cam. The cam shaft can be implemented in any axial section in which a cam is disposed, in the manner depicted in FIGS. 4 to 6c. In its remaining axial extent it can be implemented in conventional manner, for example according to FIG. 3.

The cam forming the function part 2 in the embodiment example according to FIGS. 4 to 6c has a formation analogous to that described in conjunction with FIG. 1, wherein it can have a decreased diameter in comparison to the implementation of the cam shaft according to FIG. 3.

The cam shaft comprises in the axial section depicted in FIGS. 4 to 6c a first hollow shaft 3a and a second hollow shaft 3b. These two hollow shafts are separate parts spaced apart from one another in the direction of the rotational axis 11 of the cam shaft, which parts are disposed coaxially with respect to one another, wherein their axes coincide with the rotational axis 11 of the cam shaft, and have preferably the same inner and outer diameters.

The hollow shafts 3a, 3b are rigidly connected with one another via a function unit 13, thus are torsion-tight and axially nondisplaceable with respect to one another. The function unit 13 comprises in this embodiment the function part 2 and a shaft part 12 produced in a separate fabrication process, which part forms a type of “auxiliary shaft”. The shaft part 12 is, for example, implemented as shown as a hollow shaft; however, it can also be implemented as a solid part. The function part 2, which is disposed axially between the hollow shafts 3a, 3b, is connected with the shaft part 12 at least torsion-tight, preferably also connected nondisplaceably in the axial direction, thus is overall rigidly connected. The function part 2 can, as depicted, be in contact on the front-side ends of hollow shafts 3a, 3b or it can also be spaced apart therefrom.

The connection between the function part 2 and the shaft part 12 can, for example, be implemented as an axial press connection, such as is known in conventional cam shafts (cf. FIG. 3) for the connection between the cams and the bearing shaft. The shaft part 12 is preferably provided in the region of the press fit with the function part 2 with material elevations 22, for example beads, webs, teeth or the like. These material elevations 22 are deformed when pressing on the function part 2, whereby a rigid and secure press fit can be implemented.

The material elevations 22 can be implemented as encircling elevations, wherein they can have a pitch in the manner of threadings or can extend annularly. Such material elevations 22 can also be denoted as roller-burnishings or as annular groove knurling. The material elevations 22 could also have a different form, for example, they could extend in the axial direction. Such axially extending material elevations are also referred to as axial groove knurling. Webs, beads or teeth extending in an oblique direction or other types of material elevations, for example diamond knurling, could also be provided.

The material elevations 22 are preferably implemented through material displacement, in particular by means of rolling tools, such as also serve for the production of rolled-on threadings. One advantage of the implementation through forming comprises the material reinforcements entailed therein, which leads to a reduction of metal removed and the improvement of the connection.

In addition to the material elevations 22 on the shaft part 12, or instead of them, the wall 5 delimiting the inner cutout A of the cam can be provided with material elevations. These material elevations can have the form previously described in connection with the outer surface of shaft part 12 in the region of the press fit with the function part 2. A preferred embodiment of such material elevations on the wall 5, delimiting the inner cutout A, of the function part 2 are herein teeth extending in the axial direction. When the function part 2 is being pressed on such teeth can form out indentations in the latter or in its material elevations 22. Through these indentations a connection can be implemented acting under form closure against a relative turning out of place of the function part 2 with respect to the shaft part 12. Such indentations are preferably formed during the axial pressing-on of the function parts 2 such that they are not, or only to a small degree, chip-forming, but rather are formed entirely or at least largely through material displacement.

The diameter of the inner cutout A of the cam is advantageously minimally greater than the outer diameter of the shaft part 12, such that both parts can be slid with minimal play one into the other, wherein only through the diameter enlargement or diameter reduction connected with the introduction of the material elevations into at least one of the two parts, the partial overlap necessary for the interference fit is brought about. It becomes thereby possible to compensate tolerances for the production of the cutout A of the cam and the shell surface of the shaft part 12. The connection is advantageously additionally laid out so that a widening of the outer diameter of the cam is nearly prevented. The values of the widening of the outer diameter should be below 0.2 mm, especially preferably below 0.05 mm. This lowers the cracking risk in the wall 5 delimiting the cutout A such that the connection strength is ensured.

The shaft part 12 projects with one engagement section 12a into the inner opening 14 of the first hollow shaft 3a and with one engagement part 12b into the inner opening 14 of the second hollow shaft 3b. The engagement sections 12a, 12b are herein each connected through a press fit with the end sections of the hollow shafts 3a, 3b receiving them. Through this press fit the particular engagement section 12a, 12b is connected with the particular hollow shaft 3a, 3b nondisplaceably in the axial direction as well as torsion-tight. The implementation of the press fit takes place through a particular axial pressing-in of the engagement section 12a, 12b into the end section of the particular hollow shaft 3a, 3b.

The engagement sections 12a, 12b are preferably provided with material elevations 23. These material elevations 23 are deformed when the particular engagement section 12a, 12b is pressed into the particular inner opening 14, whereby a strong and secure press fit can be implemented.

The material elevations 23 can for example be formed by beads, webs, teeth or the like. In a feasible physical form these material elevations 23 extend in the circumferential direction. They can herein have an annular course or a pitch of the type of threading can be provided. Such material elevations 23 can also be referred to a roller-burnishings or as annular groove knurling.

The material elevations 23 formed by beads, webs, teeth or the like could also have a different form, for example they could extend in the axial direction. Such axially extending material elevations are also referred to as axial groove knurling. Beads, webs or teeth or other types of material elevations, for example diamond knurling, extending in an oblique direction, could also be provided.

The material elevations 23 are preferably implemented by material displacement, in particular by means of rolling tools, such as also serve for the production of rolled-on threadings. One advantage of the implementation using a forming process comprises the material reinforcements entailed therein, which leads to a reduction of metal removed and the improvement of the connection.

In addition to the material elevations 23 of the engagement sections 12a, 12b or instead of them, the wall delimiting the particular inner opening 14 can be provided with material elevations at least in that section in which the press fit with the engagement section 12a, 12b takes place. These material elevations can have the form previously described in connection with the engagement sections. A preferred embodiment of such material elevations on the wall, delimiting the inner opening 14 are herein teeth extending in the axial direction. When the associated engagement section 12a, 12b is being pressed in, such teeth can form out indentations in the latter or in its material elevations. Through these indentations a connection can be implemented acting under form closure against a relative turning out of place of the engagement section 12a, 12b with respect to the hollow shaft 3a, 3b. Such indentations are preferably formed during the pressing-in of the engagement section 12a, 12b such that they are not at all, or only to a small degree, metal removing but rather are formed entirely or at least largely through material displacement.

The inner diameter of the inner opening 14 of the particular hollow shaft 3a, 3b is advantageously minimally greater than the outer diameter of the particular engagement section 12a, 12b, such that both parts can be slid with minimal play one into the other, wherein only through the diameter enlargement or diameter reduction, respectively, connected with the introduction of the material elevations, in at least one of the two parts, the partial overlap necessary for the interference fit is brought about. It becomes thereby possible to compensate tolerances for the production of the inner form of hollow shafts 3a, 3b and of the shell surface of the engagement section 12a, 12b. The connection is advantageously additionally laid out so that a widening of the outer diameter of the region of the particular hollow shaft 3a, 3b, in which the particular engagement section 12a, 12b is received, is nearly prevented. The values of the widening of the outer diameter should be below 0.2 mm, especially preferably below 0.05 mm. This lowers the cracking risk in the wall of the particular hollow shaft 3a, 3b, such that the connection strength is ensured.

If in the embodiment of the cam shaft of function part 2 depicted in FIGS. 4 to 6c has the same collar width 7 as in the conventional cam shaft according to FIG. 3, the outer diameter of the cam shaft in the base circle region 6 is lower by the wall thickness of the hollow shafts 3a, 3b than in the conventional cam shaft. The outer diameter in the region of the cam peak (at identical cam elevation) is also smaller by that amount.

In the embodiment example according to FIGS. 4 to 6 the outer diameter of the function part 2 in the base circle region is smaller than the outer diameter of the hollow shafts 3a, 3b.

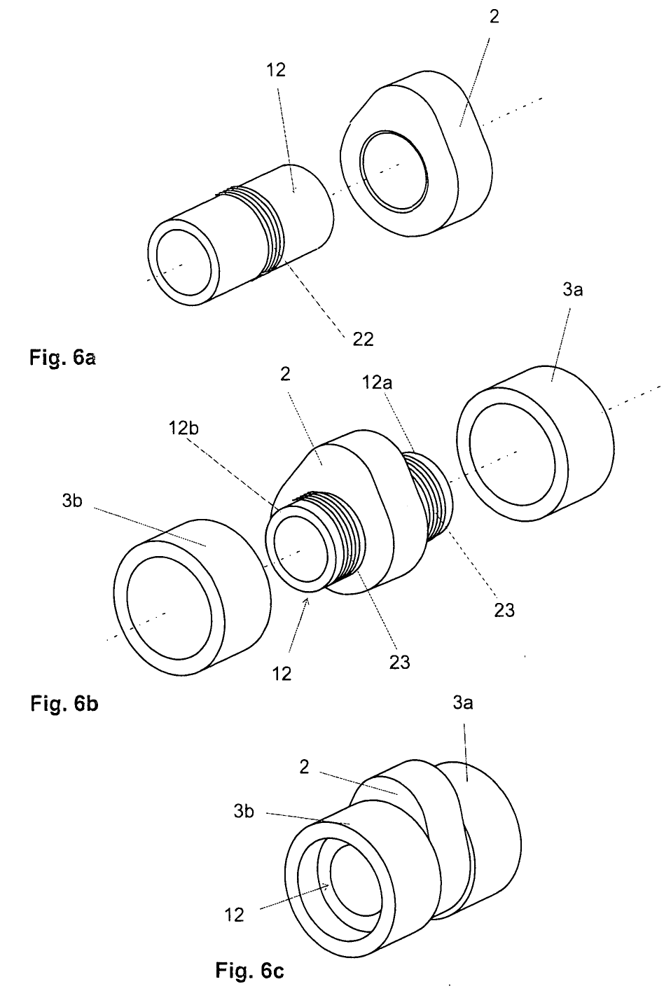

The production is preferably carried out as depicted in FIGS. 6a to 6c. Herein, first, the material elevations 22 are implemented on the outer surface of the shaft part 12 in its axial region seating tightly the cam 2 and/or on the wall 5 delimiting the cutout A of cam 2. Subsequently the cam 2 is axially pressed onto the shaft part 12. The material elevations 23 are subsequently implemented on the engagement sections 12a, 12b and/or on the walls delimiting the inner openings 14 of the hollow shafts 3a, 3b in their sections receiving the engagement sections 12a, 12b. This state is depicted in FIG. 6b. The engagement sections 12a, 12b are subsequently pressed into the end sections of the hollow shafts 3a, 3b (cf. FIG. 6c).

Various modifications thereof are conceivable and feasible. For example, before the cam 2 is pressed on, the material elevations 23 could also be implemented on one of the engagement sections 12a, 12b, and the cam 2 be pressed on from the other side. It is, furthermore, conceivable and feasible to implement the outer diameter of the material elevations 22 to be greater than the outer diameter of the material elevations 23 and to implement the inner diameter of the cam 2 greater than the outer diameter of the material elevations 23, however, smaller than the outer diameter of the material elevations 22 or to produce such an inner diameter of cam 2 after the wall 5 has been provided with material elevations. The material elevations 22, 23 on the shaft part 12 could herein all be formed before the pressing-on processes.

The function part 2 could as a cam also be implemented, for example, in the form of a cam disk or eccentric disk 2b, such as depicted by example in FIG. 2.

The function part 2 could, moreover, also be a function part of the cam shaft other than a cam, for example, a bearing, a centrally disposed drive piece, an axial bearing disk, a sensor ring or a cam shaft adjuster.

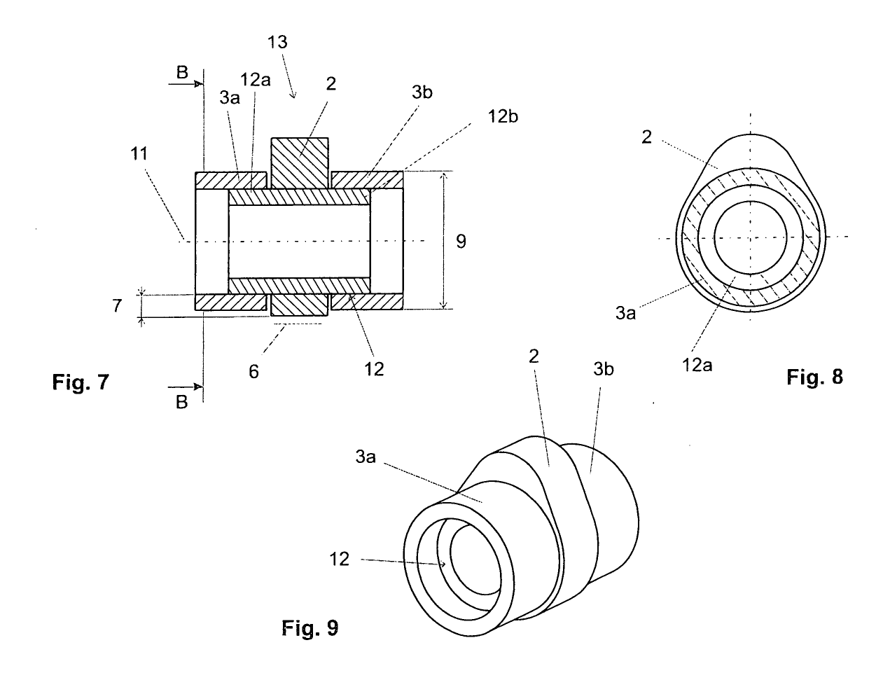

The embodiment variant according to FIGS. 7 to 9 only differs from the embodiment previously described thereby that the outer diameter of the function part 2 is here greater in the base circle region than the outer diameter of the hollow shafts 3a, 3b.

The invention is applicable for the case that the structural function part 2, in particular the cams, adjoining flush up to the adjacent hollow shaft 3a or 3b, respectively, are disposed without axial interspace, as well as also for the case that between the structural function part 2 and the adjacent end of the hollow shaft an axial space is provided. FIG. 4 illustrates an embodiment in which the structural function part is directly in contact on the adjacent hollow shafts 3a or 3b, respectively, without axial spacing. In FIG. 7 a small axial spacing is shown schematically.

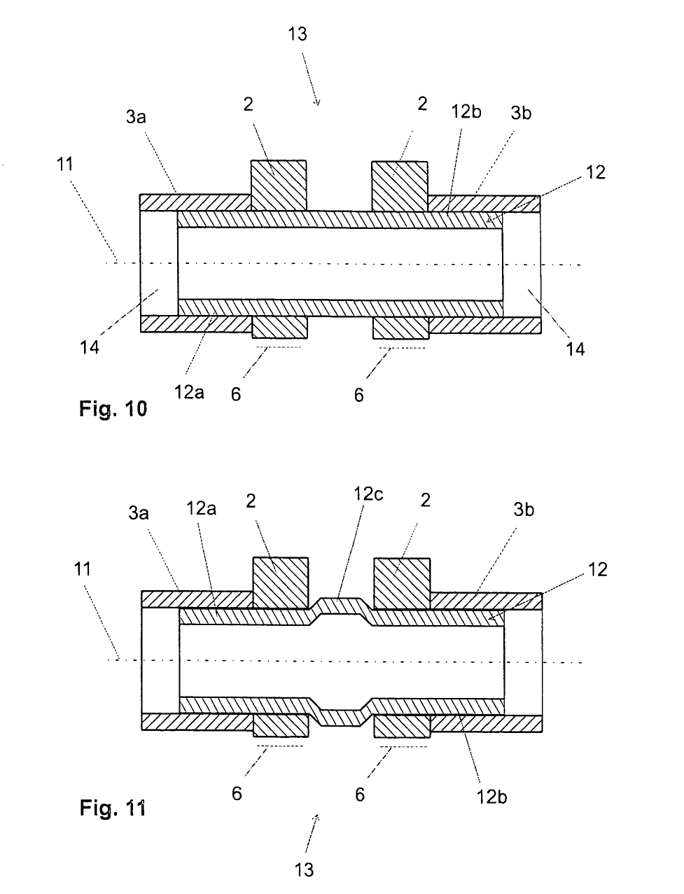

The embodiment example according to FIG. 10 only differs from the embodiment example according to FIGS. 7 and 9 thereby that the function unit 13 here comprises two function parts 2 axially spaced apart, for example cams 2a with cam peaks or cam disk or eccentric disks 2b, which are disposed on a common shaft part 12. Engagement sections 12a, 12b of shaft part 12 are connected through press fit in the previously described manner with the first and second hollow shaft 3a, 3b. The connection of the function parts 2 with the shaft part 12 can also be carried out in the already described manner. Function parts 2 are again located axially between the first and second hollow shaft 3a, 3b, wherein, as depicted, each of the two function parts 2 can be in contact at the front end on one of the two hollow shafts 3a, 3b.

The embodiment depicted in FIG. 11 only differs from the embodiment depicted in FIG. 10 thereby that the shaft part 12 in the region axially between the function parts 2 includes a radially widened section 12c. The radially widened section 12c can assume a special function for the drive shaft. This region can, for example, serve as a hexagon for the formation of an engagement contour for a tool for bolting, positioning or mounting the drive shaft during the assembly in a combustion engine. Alternatively, or in combination, the function parts 2 can also additionally be secured against axial displacement, thus on the one hand through the particular hollow shaft 3a, 3b, on which they are in contact at the end sides, on the other hand through the radially widened section 12c of the shaft part 12 (in addition to the axial mounting effected by the preferred press fit). The shaft part 12 is preferably again implemented hollow, wherein a solid implementation is conceivable and feasible.

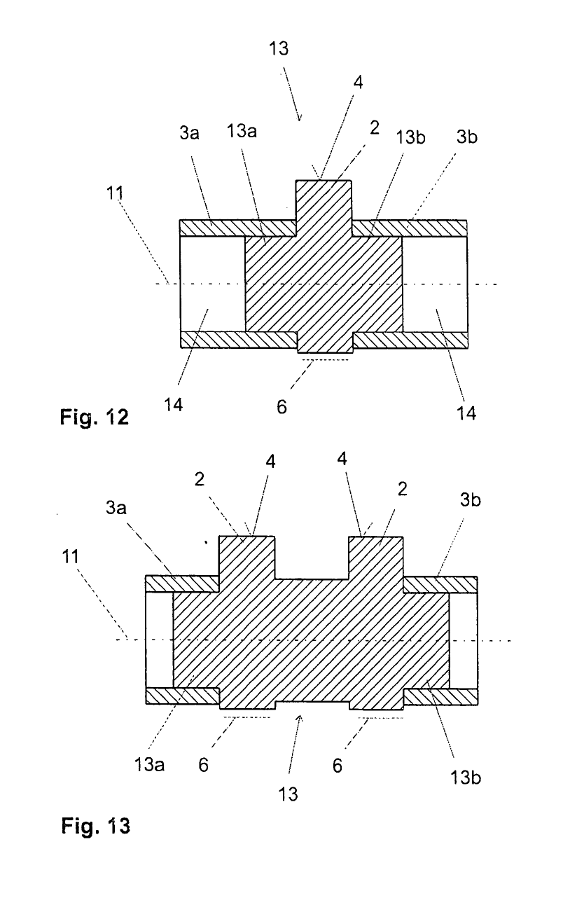

The embodiment according to FIG. 12 differs from the embodiment according to FIGS. 7 to 9 thereby that the function unit 13 is here implemented in one piece. In an axially central region of the function unit 13 a section of the function unit 13 forms the function part 2. This part 2 includes, for example, again a function face 4 in the manner of a cam or in the manner of a cam disk or eccentric disk. The function part 2 of the function unit 13 is located axially between the first and second hollow shaft 3a, 3b. The function unit 13 comprises, further, first and second axially extending engagement sections 13a, 13b. These are connected with the first and second hollow shaft 3a, 3b through a press fit in the manner already described. As an alternative to the production through machining, such function units can, for example, be produced through sintering or forging.

The embodiment depicted in FIG. 13 differs from that depicted in FIG. 12 thereby that the integrally implemented function unit 13 here comprises two function parts 2 which are axially spaced apart with respect to one another and, referring to the direction of the rotational axis 11, are located between the first and second hollow shaft 3a, 3b. The two function parts 2 are connected with one another through an axially extending connection section 13c, coaxial with the hollow shafts 3a, 3b, of the function unit 13.

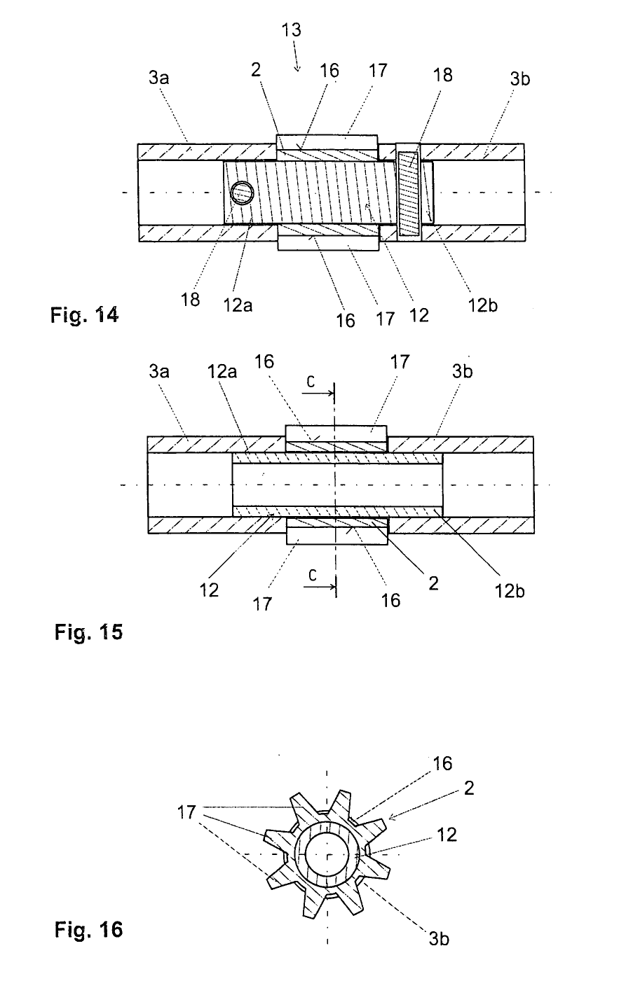

A further embodiment example of the invention is depicted in FIG. 14. The drive shaft comprises here at least one function part 2 in the form of a gear-wheel. The gear-wheel has teeth 17 and interspaced tooth root surfaces 16. The function part 2 implemented as a gear-wheel, in turn, is part of a function unit 13 via which the coaxial hollow shafts 3a, 3b, preferably having identical inner and outer diameters, are rigidly connected with one another. The function unit 13 and the hollow shafts 3a, 3b are again structural parts implemented in separate fabrication processes.

Apart from the function part 2 implemented in the form of a gear-wheel, the function unit 13 comprises a shaft part 12 implemented in this embodiment example separately, for example as depicted, solid part 12, on which the gear-wheel 2 is fixed torsion-tight and nondisplaceable in the axial direction, for example through a press fit. Such a press fit can have the implementation already described in connection with the fixing of the function part 2 in the form of a cam, on a shaft part 12. The shaft part 12, which is solid, includes a first and a second engagement section 12a, 12b, via which it is held through a particular press fit in the end section of the particular hollow shaft 3a, 3b. These press connections can be implemented as already described.

The engagement sections in this embodiment example are additionally secured with respect to the hollow shafts 3a, 3b through securement pins 18. The securement pins 18 penetrate radial openings in shaft part 12 and in hollow shafts 3a, 3b. These radial openings represent side form elements in the engagement sections 12a, 12b and in the end sections of the hollow shafts 3a, 3b receiving the engagement sections 12a, 12b.

The embodiment example according to FIGS. 15 and 16 differs from the embodiment according to FIG. 14 thereby that the securement pins 18 are here omitted and the function unit 13, instead of a solid shaft part, here comprises a hollow shaft part 12.

In the manner according to the invention function units with other types of function parts, for example other types of gearing parts, such as friction wheels, etc., can be connected with hollow shafts of the drive shaft.

### LEGEND TO THE REFERENCE SYMBOLS

1 Drive shaft
2 Function part
2a Cam
2b Cam disk or eccentric disk
3 Bearing shaft
3a First hollow shaft
3b Second hollow shaft
4 Function face
5 Wall
6 Base circle region
7 Flange width
8 Inner diameter
9 Inlet chamfer
10 Bearing diameter
11 Rotational axis
12 Shaft part
12a Engagement section
12b Engagement section
12c Widened section
13 Function unit
13a Engagement section
13b Engagement section
13c Connection section
14 Inner opening
16 Tooth root surface
17 Tooth
18 Securement pin
19 Outer diameter
20 Bearing
21 Drive piece
22 Material elevation
23 Material elevation
A Inner cutout

1-17. (canceled)

18. A drive shaft comprising
at least two coaxial hollow shafts spaced apart in the direction of the rotational axis of the drive shaft, each of the hollow shafts having an inner opening, and
at least one function unit comprising at least one function part disposed, with reference to the direction of the rotational axis of the drive shaft, between a first and a second of the hollow shafts and first and second engagement sections extending in the direction of the rotational axis of the drive shaft, of which the first engagement section is disposed in the inner opening of the first hollow shaft and of which the second engagement section is disposed in the inner opening of the second hollow shaft,
wherein the engagement sections of the function unit are pressed into the inner openings of the hollow shafts with the formation of a particular press fit, and the first and second hollow shafts are rigidly connected with one another via the function unit, and
wherein the outer surfaces of the engagement sections include material elevations and/or the wall, delimiting the inner opening of the hollow shaft, of the particular hollow shaft includes material elevations in the end section, in which the press fit is formed with the particular engagement section of the function unit.

19. The drive shaft as claimed in claim 18, wherein the material elevations of the engagement sections and/or of the wall delimiting the inner opening of the hollow shaft are implemented as webs, beads or teeth.

20. The drive shaft as claimed in claim 18, wherein the engagement sections coaxial with respect to the rotational axis of the drive shaft.

21. The drive shaft as claimed in claim 18, wherein the function unit comprises a shaft part, which includes the first and second engagement sections, wherein the function part and the shaft part are separate parts and the function part is connected torsion-tight with the shaft part.

22. The drive shaft as claimed in claim 21, wherein the function part is rigidly connected with the shaft part.

23. The drive shaft as claimed in claim 21, wherein the shaft part penetrates an inner cutout of the function part.

24. The drive shaft as claimed in claim 23, wherein the function part is connected with the shaft part through a press fit.

25. The drive shaft as claimed in claim 24, wherein the outer surface of the shaft part includes in the axial section of the press connection with the function part material elevations and/or the wall, delimiting the inner cutout of the function apt, of the function part includes material elevations.

26. The drive shaft as claimed in claim 21, wherein the shaft part is implemented in the form of a hollow shaft.

27. The drive shaft as claimed in claim 26, wherein at the ends directed toward one another of the hollow shafts and/or at the ends of the engagement sections inlet chamfers are implemented.

28. The drive shaft as claimed in claim 18, wherein the function part is a cam with a cam peak or a cam implemented in the form of a cam disk or eccentric disk.

29. The drive shaft as claimed in claim 18, wherein the function part is a gear-wheel.

30. The drive shaft as claimed in claim 18, wherein the outer surfaces of the engagement sections are implemented substantially in the form of a cylinder shell.

31. The drive shaft as claimed in claim 18, wherein the inner surfaces of the hollow shafts are implemented substantially in the form of a cylinder shell at least in their axial regions receiving the engagement sections.

32. A method for the production of a drive shaft as claimed in claim 18, wherein the first and second hollow shaft and the at least one function unit are produced in separate fabrication processes and for the rigid connection of the first and second hollow shaft the engagement sections of the function unit are pressed into the end sections of the inner openings of the hollow shafts directed toward one another.

33. The method as claimed in claim 32, wherein for the rigid connection of the function part with a shaft part including the engagement sections of the function unit the function part is pressed with an inner cutout onto the shaft part.

34. The method as claimed in claim 33, wherein the diameter of the inner cutout of the function part is initially implemented with play with respect to the outer diameter of the shaft part and the partial overlap necessary for the interference fit is formed through a forming implementation of material elevations on the outer surface of the shaft part and/or on the wall delimiting the inner cutout, of the function part.

35. The method as claimed in claim 33, wherein the inner diameters of the hollow shafts in their axial regions receiving the engagement sections are initially implemented with play with respect to the outer diameters of the engagement sections and the partial overlap necessary for the interference fit is implemented through a forming implementation of material elevations on the outer surfaces of the engagement sections and/or on the surfaces of the walls delimiting the inner openings of the hollow shafts.
